(19) United States
(12) Patent Application Publication
(10) Pub. No.: US 2015/0239205 A1
(43) Pub. Date: Aug. 27, 2015

(54) COMPOSITE MATERIAL AND METHODS OF MAKING AND USING THE SAME

(71) Applicant: GM Global Technology Operations LLC, Detroit, MI (US)

(72) Inventor: Christopher G. Basela, Ortonville, MI (US)

(73) Assignee: GM Global Technology Operations LLC, Detroit, MI (US)

(21) Appl. No.: 14/189,131

(22) Filed: Feb. 25, 2014

(51) Int. Cl. B32B 5/02; B32B 15/20; B32B 37/12; B32B 5/06

(52) U.S. Cl. CPC B32B 5/024; B32B 5/06; B32B 15/20; B32B 37/12; B32B 2250/03; B32B 2260/021

(57) ABSTRACT

A number of variations may include a composite material and method of manufacture thereof wherein the composite material may be fabricated from a core, a weave, a fiber and a bonding agent, wherein the weave may be positioned between the core and the fiber.

### TECHNICAL FIELD

The field to which the disclosure generally relates to includes composite materials, including, but not limited to composite materials used in vehicle frames and structures, such as, but not limited to frames or structures included in passenger vehicles, motor cycles, bicycles, rough terrain vehicles, watercraft, trains, aircraft, or spacecraft.

### BACKGROUND

Currently, some composite materials may be formed to contain aluminum and carbon to provide floor or bulkhead construction in some vehicles.

### SUMMARY OF ILLUSTRATIVE VARIATIONS

A number of variations may include a product comprising a core, a weave, a fiber and a bonding agent, wherein the weave may be positioned between the core and the fiber.

A number of variations may include shows a product comprising a composite material comprising a metal core, a fiber comprising carbon, a weave comprising glass, and a bonding agent, wherein the weave may be positioned between the metal core and the fiber.

Another variation of the invention may include a method of manufacturing a composite material including: providing a core, a fiber, a weave, and a bonding agent, positioning the weave over the core, positioning the fiber and bonding agent over the weave, and curing to form the composite material.

Another variation of the invention may include a method of manufacturing a composite material comprising: providing a mold cavity, a core, a first fiber, a second fiber, a first weave, a second weave, a first bonding agent, and a second bonding agent, positioning the first fiber and the first bonding agent into the mold cavity, positioning the first weave over the first fiber, positioning the core over the first weave, positioning the second weave over the core, positioning the second fiber and the second bonding agent over the second weave, closing the mold cavity, and curing to form the composite material.

Other illustrative variations within the scope of the invention will become apparent from the detailed description provided hereinafter. It should be understood that the detailed description and specific examples, while disclosing optional variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a cross-sectional view of one variation of the composite material.

FIG. 1A is a plain view look at the top face of the core of the composite material in FIG. 1.

FIG. 2 is a cross-sectional view of one variation of the composite material.

FIG. 3 is a comparison line chart of ⅓ octave band center frequency vs. sound transition loss of a variation of a composite material and three variations of prior art composite material.

FIG. 4 is a comparison line chart of displacement vs. force of a variation of a composite material and two variations of prior art composite material.

### DETAILED DESCRIPTION OF ILLUSTRATIVE VARIATIONS OF THE INVENTION

The following description of the variations is merely illustrative in nature and is in no way intended to limit the scope of invention, its application, or uses.

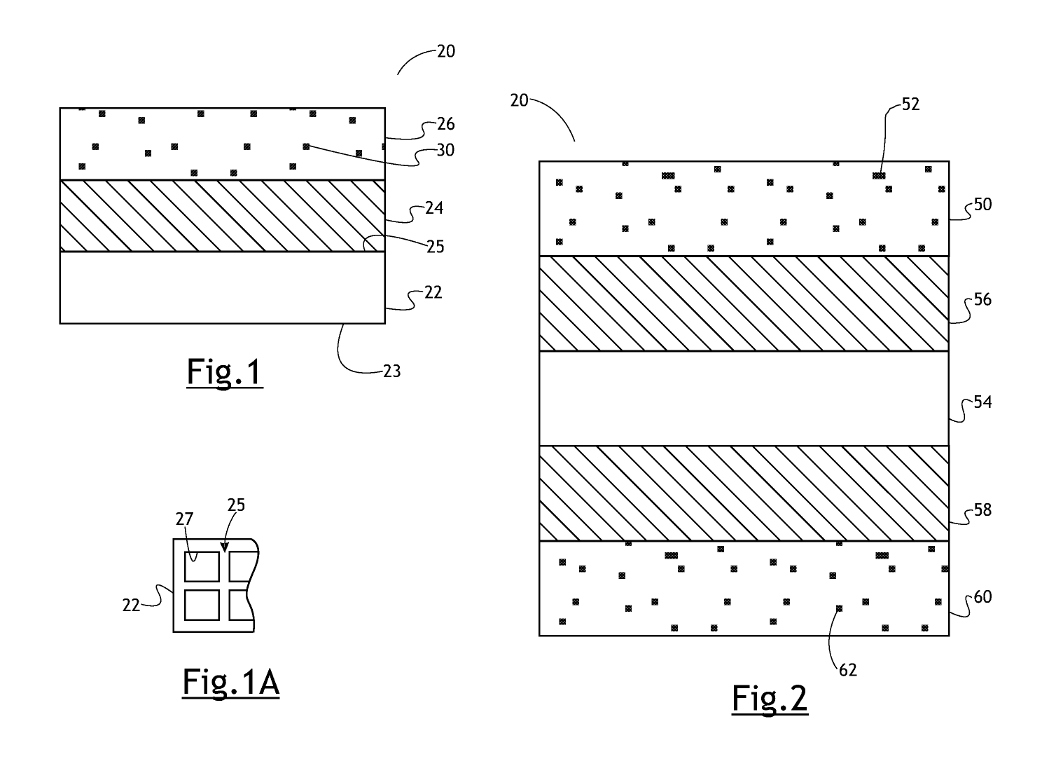

A composite material 20 is provided in FIG. 1. Such a composite material 20 may be useful in applications such as bulkheads, floors, front dashboards, rear seatbacks of a vehicle or may be used for other applications. The composite material may provide more resistance to corrosion without sacrificing structural failure in varying conditions while providing a mass savings over other composite materials such as metal. In one variation, the composite material 20 may include a plurality of layers. In one variation, the composite material 20 may include a core 22. The core 22 may include a metal. The metal may be aluminum, titanium, stainless steel, or may be another type of metal. The core 22 may be in a honeycomb structure. The honeycomb structure may include a plurality of n-sided polygonal holes or circles 27 extending through a bottom face 23 and/or a top face 25 of the core 22. The n-sided polygonal holes may include a hole in the shape of a triangle, square, pentagon, hexagon, heptagon, or may be another type. The core 22 may include an aluminum hex cell material. The core 22 can be manufactured in a two dimension or three dimensional orientation. The core may be open or closed cell structured or may be another type. The core may include foams such as polyvinylchloride foam, polyurethane foam, polyethylene foam, polystyrene foam, syntactic foam, or metal foam, or may include balsa wood.

Still referring to FIG. 1, the composite material 20 may further include a weave 24. The weave may include a plurality of weave fibers. The weave 24 may be formed by sheets, continuous mats, or as continuous filaments. The weave 24 may include aramid fibers, carbon fibers, glass fibers, basalt fibers, polymer fibers, wood fibers, cellulose, or another similar functioning fiber material. The weave 24 may include a fiber reinforced polymer. The weave 24 may include fiberglass or may include other types of insulation. The weave 24 may be formed using a hand lay-up operation, a spray lay-up operation, a pultrusion operation, a chopped strand mat, vacuum bag moulding, pressure bag moulding, autoclave moulding, resin transfer moulding, vacuum assisted resin transfer moulding, bladder moulding, compression moulding, mandrel wrapping, wet layup, chopper gun, filament winding, or may be formed another way. The weave 24 may be manufactured or woven through weaving, knitting, braiding, stitching, plain weaving, satin weaving, or may be manufactured in another way. The weave 24 may be manufactured in a two dimensional or three dimensional orientation. The weave 24 may include short-fiber reinforced materials or continuous fiber-reinforced materials or may include another type. The weave 24 may have various widths, lengths and/or diameters. The weave 24 may include a fiber reinforced polymer. The weave 24 may be preimpregnated, coated, or otherwise in contact with a bonding agent 30.

Still referring to FIG. 1, the composite material 20 may further include a fiber 26. The fiber 26 may include a plurality of subfibers. The fiber 26 may be formed by sheets, continuous mats, or as continuous filaments. The fiber 26 may include aramid fibers, carbon fibers, aluminum fibers, glass fibers, carbon nanotubes, basalt fibers, polymer fibers, wood fibers, cellulose, or another similar functioning fiber material. The fiber 26 may include a fiber reinforced polymer, carbon-fiber-reinforced polymer, carbon-fiber-reinforced plastic, carbon-fiber reinforced thermoplastic, or carbon nanotube reinforced polymer. The fiber 26 may be formed using hand lay-up operation, a spray lay-up operation, a pultrusion operation, a chopped strand mat, vacuum bag moulding, pressure bag moulding, autoclave moulding, resin transfer moulding, vacuum assisted resin transfer moulding, bladder moulding, compression moulding, mandrel wrapping, wet layup, chopper gun, filament winding, or may be formed another way. The fiber 26 may be manufactured or woven through weaving, knitting, braiding, stitching, plain weaving, satin weaving, or may be manufactured in another way. The fiber 26 may be manufactured in a two dimensional or three dimensional orientation. The fiber 26 may include short-fiber reinforced materials or continuous fiber-reinforced materials or may include another type. The fiber 26 subfibers may have various widths, lengths, and/or diameters. The fiber 26 may be preimpregnated, coated, or otherwise in contact with a bonding agent 30.

Still referring to FIG. 1, a bonding agent 30 may be held in contact with the fiber 26, core 20, or weave 24. This contact may result in adherence or bonding between the bonding agent 30, the fiber 26, core 20, or weave 24, or any combination thereof. The bonding agent 30 may include vinylester resin, polyester resin, epoxy resin, phenolic resin, or modified phenolic resin or may be another type. The adhesive may be reactive or non-reactive. A first bonding agent and a second bonding agent may be the same or different in composition.

The composite material 20 may be produced by various fabrication or manufacturing methods. The composite material 20 may be in two or three dimensional orientation. In one variation the core 22, fiber 26, weave 24, and bonding agent 30 may be positioned within a mold, compacted, and cured. In one variation, a fiber 26 and bonding agent 30 may be positioned into a mold cavity. The fiber 26 may be preimpregnated with the bonding agent 30 in one variation. In other variations the bonding agent 30 may be coated, saturated, positioned in a layer, or otherwise contacted with the fiber 26. The bonding agent 30 may also be preimpregnated, coated, saturated, positioned in a layer, or otherwise contacted with the core 22 or weave 24 or other components. In one variation a weave 24 may be positioned over the fiber 26 in the mold cavity. In one variation a core 22 may be positioned over the weave 24. A mold 70 may be closed in one variation to form and cure a composite material 20. In the final composite material the weave 24 may be positioned between the core 22 and the fiber 26. Other methods may be used to form the composite material 20. These methods include, but are not limited to, hand lay-up operation, a spray lay-up operation, a pultrusion operation, a chopped strand mat, vacuum bag moulding, pressure bag moulding, autoclave moulding, resin transfer moulding, injection moulding, vacuum assisted resin transfer moulding, bladder moulding, compression moulding, mandrel wrapping, face sheet rolling, wet layup, chopper gun, filament winding, or may be formed another way. The composite material 20 may be formed to sheets in an orientation of the core 22, fiber 26, bonding agent 30, and weave 24 in any combination or layer formation. The composite material 20 may be finished with other methods for a final design. The mold may be tooled to form the desired shape or variation of the composite material 20 for its intended application. A person of skill in the art would recognize these techniques.

In one variation a first fiber 50 and first bonding agent 52 may be positioned into a mold cavity. The first fiber 50 may be preimpregnated with the first bonding agent 52 in one variation. In other variations the first bonding agent 52 may be coated, saturated, positioned in a layer, or otherwise contacted with the first fiber 50. The first bonding agent 52 may also be preimpregnated, coated, saturated, positioned in a layer, or otherwise contacted with the core 54 or first weave 56 or other components. In one variation a first weave 56 may be positioned over the first fiber 50 in the mold cavity. In one variation a core 54 may be positioned over the first weave 56. In one variation a second weave 58 may be positioned over the core 54. In one variation a second fiber 60 may be positioned over the second weave 58. The second fiber 60 may be preimpregnated with a second bonding agent 62 in one variation. In other variations the second bonding agent 62 may be coated, saturated, positioned in a layer, or otherwise contacted with the second fiber 60. The second bonding agent 62 may also be preimpregnated, coated, saturated, positioned in a layer, or otherwise contacted with the core 54 or second weave 58 or other components. A mold 70 may be closed in one variation to form and cure a composite material 20 as shown in FIG. 2. Other methods may be used to form the composite material 20. These methods include, but are not limited to, hand lay-up operation, a spray lay-up operation, a pultrusion operation, a chopped strand mat, vacuum bag moulding, pressure bag moulding, autoclave moulding, resin transfer moulding, injection moulding, vacuum assisted resin transfer moulding, bladder moulding, compression moulding, mandrel wrapping, wet layup, chopper gun, filament winding, or may be formed another way. The composite material 20 may be formed to sheets in an orientation of the core 54, first fiber 50, first bonding agent 52, first weave 56, second fiber 60, second bonding agent 62 and second weave 58 in any combination or layer formation. The composite material 20 may be finished with other methods for a final design. The mold may be tooled to form the desired shape or variation of the composite material 20 for its intended application. A person of skill in the art would recognize these techniques.

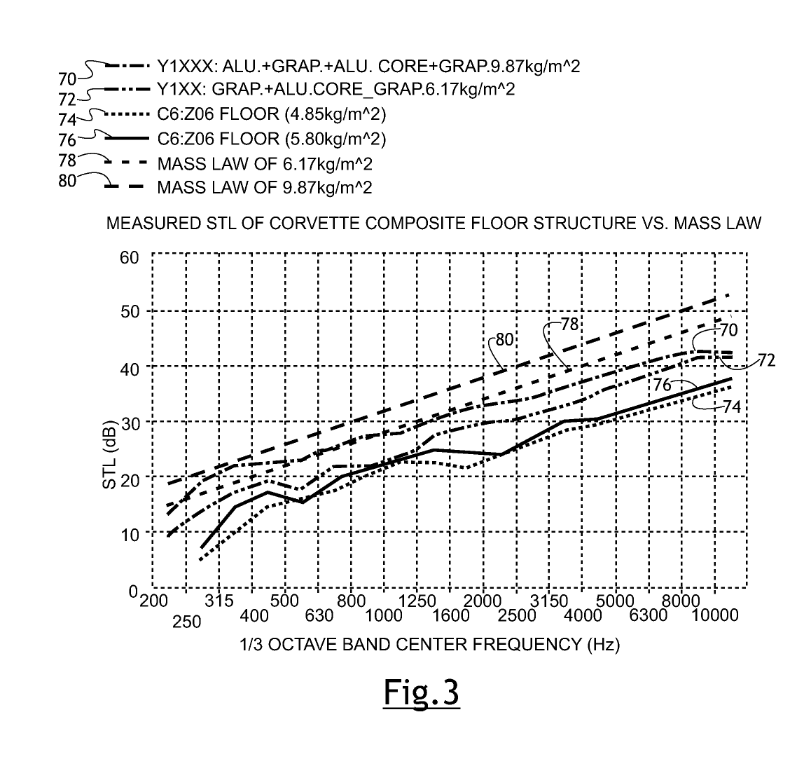

FIG. 3 is a comparison line chart of ⅓ octave band center frequency (Hz) vs. sound transition loss (dB) of a variation of a composite material 20 and three variations of prior art composite materials. Also shown are the mass law lines of 6.17 kg/m² and 9.87 kg/m². The Y1XX composite material 20 may show improved noise transmission level reduction without the use of external acoustical treatments. The composite material 20 may be useful for soundproofing applications.

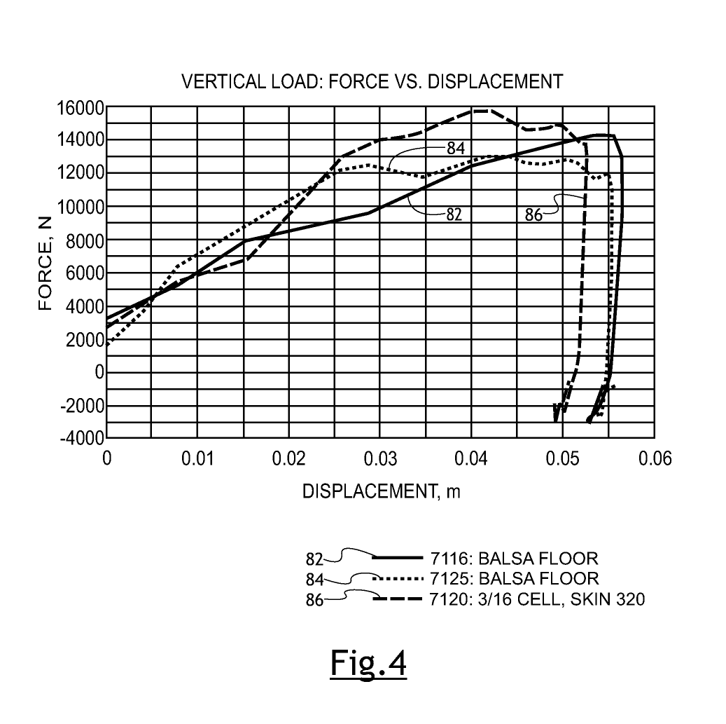

FIG. 4 is a comparison line chart of displacement vs. force of a variation of a composite material and two variations of prior art composite materials. The 7120 composite material 20 may provide less displacement versus prior art composite materials when a larger force is applied.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product including a composite material including a core, a weave, a fiber and a bonding agent, wherein the weave is positioned between the core and the fiber.

Variation 2 may include a product as set forth in Variation 1 wherein the core includes a metal including aluminum.

Variation 3 may include a product as set forth in any of Variations 1-2 wherein the core includes a honeycomb structure including a plurality of n-sided polygonal or circular holes.

Variation 4 may include a product as set forth in any of Variations 1-3 wherein the weave includes at least one of aramid fibers, carbon fibers, glass fibers, basalt fibers, polymer fibers, wood fibers, cellulose or fiber reinforced polymer.

Variation 5 may include a product as set forth in any of Variations 1-4 wherein the fiber includes at least one of aramid fibers, carbon fibers, glass fibers, basalt fibers, polymer fibers, wood fibers, cellulose, fiber reinforced polymer, carbon-fiber-reinforced polymer, carbon-fiber-reinforced plastic, carbon-fiber reinforced thermoplastic, or carbon nanotube reinforced polymer.

Variation 6 may include a product as set forth in any of Variations 1-5 wherein the bonding agent includes a resin including at least one of vinylester resin, polyester resin, epoxy resin, phenolic resin, or modified phenolic resin.

Variation 7 may include a product as set forth in any of Variations 1-6 wherein the bonding agent is pre-impregnated into at least one of the fiber or the weave.

Variation 8 may include a product including a composite material including a metal core, a fiber including carbon, a weave including glass, and a bonding agent, wherein the weave is positioned between the metal core and the fiber.

Variation 9 may include a product as set forth in Variation 8 wherein the metal core includes aluminum.

Variation 10 may include a product as set forth in any of Variations 8-9 wherein the core includes a honeycomb structure including a plurality of n-sided polygonal or circular holes.

Variation 11 may include a product as set forth in any of Variations 8-10 wherein the bonding agent includes a resin including at least one of vinylester resin, polyester resin, epoxy resin, phenolic resin, or modified phenolic resin.

Variation 12 may include a product as set forth in any of Variations 8-11 wherein the bonding agent is pre-impregnated into at least one of the fiber or the weave.

Variation 13 may include a product as set forth in any of Variations 8-12 wherein the bonding agent bonds the fiber to at least one of the metal core or the weave.

Variation 14 may include a method of manufacturing a composite material including: providing a core, a fiber, a weave, and a bonding agent, positioning the bonding agent and weave over the core, positioning the fiber over the weave, and curing to form the composite material.

Variation 15 may include a method as set forth in Variation 14 wherein the bonding agent includes at least one of vinylester resin, polyester resin, epoxy resin, phenolic resin, or modified phenolic resin.

Variation 16 may include a method as set forth in any of Variations 14-15 wherein the core includes aluminum.

Variation 17 may include a method as set forth in any of Variations 14-16 wherein the core includes a honeycomb structure including a plurality of n-sided polygonal or circular holes.

Variation 18 may include a method as set forth in any of Variations 14-17 wherein the weave includes at least one of aramid fibers, carbon fibers, glass fibers, basalt fibers, polymer fibers, wood fibers, cellulose or fiber reinforced polymer.

Variation 19 may include a method as set forth in any of Variations 14-18 wherein the fiber includes at least one of aramid fibers, carbon fibers, glass fibers, basalt fibers, polymer fibers, wood fibers, cellulose, fiber reinforced polymer, carbon-fiber-reinforced polymer, carbon-f iber-reinforced plastic, carbon-fiber reinforced thermoplastic, or carbon nanotube reinforced polymer.

Variation 20 may include a method of manufacturing a composite material including: providing a mold cavity, a core, a first fiber, a second fiber, a first weave, a second weave, a first bonding agent, and a second bonding agent, positioning the first fiber and the first bonding agent into the mold cavity, positioning the first weave over the first fiber, positioning the core over the first weave, positioning the second weave over the core, positioning the second fiber and the second bonding agent over the second weave, closing the mold cavity, and curing to form the composite material.

Variation 21 may include a product as set forth in any of Variations 1-13 wherein the composite material is in a three dimensional orientation.

Variation 22 may include a product as set forth in any of Variations 1-13 and 21 wherein the weave includes fiberglass.

Variation 23 may include a product as set forth in any of Variations 1-13 and 21-22 wherein at least one of the core, weave, fiber, or bonding agent forms a layer.

Variation 24 may include a product as set forth in any of Variations 1-13 and 21-23 wherein the core includes an aluminum hex cell material.

Variation 25 may include a product as set forth in any of Variations 1-13 and 21-24 wherein the core includes at least one of polyvinylchloride foam, polyurethane foam, polyethylene foam, polystyrene foam, syntactic foam, metal foam, or balsa wood.

Variation 26 may include a product as set forth in any of Variations 1-13 and 21-25 wherein the fiber is formed by sheets, continuous mats, or as continuous filaments.

Variation 27 may include a product as set forth in any of Variations 1-13 and 21-26 wherein the weave is formed by sheets, continuous mats, or as continuous filaments.

Variation 28 may include a product as set forth in any of Variations 1-13 and 21-27 wherein the weave is formed by at least one of a hand lay-up operation, a spray lay-up operation, a pultrusion operation, a chopped strand mat, vacuum bag moulding, pressure bag moulding, autoclave moulding, resin transfer moulding, vacuum assisted resin transfer moulding, bladder moulding, compression moulding, mandrel wrapping, wet layup, chopper gun, or filament winding.

Variation 29 may include a product as set forth in any of Variations 1-13 and 21-28 wherein the weave is manufactured by at least one of weaving, knitting, braiding, stitching, plain weaving, or satin weaving.

Variation 30 may include a product as set forth in any of Variations 1-13 and 21-29 wherein the weave includes short-fiber reinforced materials or continuous fiber-reinforced materials.

Variation 31 may include a product as set forth in any of Variations 1-13 and 21-30 wherein the weave includes a fiber reinforced polymer.

Variation 32 may include a product as set forth in any of Variations 1-13 and 21-31 wherein the fiber is formed by sheets, continuous mats, or as continuous filaments.

Variation 33 may include a product as set forth in any of Variations 1-13 and 21-32 wherein the fiber is formed by at least one of a hand lay-up operation, a spray lay-up operation, a pultrusion operation, a chopped strand mat, vacuum bag moulding, pressure bag moulding, autoclave moulding, resin transfer moulding, vacuum assisted resin transfer moulding, bladder moulding, compression moulding, mandrel wrapping, wet layup, chopper gun, or filament winding.

Variation 34 may include a product as set forth in any of Variations 1-13 and 21-33 wherein the fiber is manufactured by at least one of weaving, knitting, braiding, stitching, plain weaving, or satin weaving.

Variation 35 may include a product as set forth in any of Variations 1-13 and 21-34 wherein the fiber includes short-fiber reinforced materials or continuous fiber-reinforced materials.

Variation 36 may include a product as set forth in any of Variations 1-13 and 21-35 wherein the bonding agent may be reactive.

Variation 37 may include a product as set forth in any of Variations 1-13 and 21-37 wherein composite material may be in a three dimensional orientation.

Variation 38 may include a method as set forth in any of Variations 14-20 wherein the composite material is formed by at least one of a hand lay-up operation, a spray lay-up operation, a pultrusion operation, a chopped strand mat, vacuum bag moulding, pressure bag moulding, autoclave moulding, resin transfer moulding, injection moulding, vacuum assisted resin transfer moulding, bladder moulding, compression moulding, mandrel wrapping, wet layup, chopper gun, or filament winding.

Variation 39 may include a product as set forth in any of Variations 1-13, 21-37 wherein the composite material is used as a floor or bulkhead in a vehicle.

Variation 40 may include a method as set forth in any of Variations 20 and 38 wherein the first bonding agent and second bonding agent are the same composition.

Variation 41 may include a product as set forth in any of Variations 1-13, 21-37, and 39 wherein the core is open or closed cell structured.

Variation 42 may include a method as set forth in any of Variations 14-20, 38, and 40 wherein the mold is tooled to form the desired shape or variation of the composite material for its intended application.

The above description of select variations within the scope of the invention is merely exemplary in nature and, thus, other variations or variants thereof are not to be regarded as a departure from the spirit and scope of the invention.

What is claimed is:

1. A product comprising:
a composite material comprising a core, a weave, a fiber and a bonding agent, wherein the weave is positioned between the core and the fiber.

2. A product as described in claim 1 wherein the core comprises a metal comprising aluminum.

3. A product as described in claim 1 wherein the core comprises a honeycomb structure comprising a plurality of n-sided polygonal or circular holes.

4. A product as described in claim 1 wherein the weave comprises at least one of aramid fibers, carbon fibers, glass fibers, basalt fibers, polymer fibers, wood fibers, cellulose or fiber reinforced polymer.

5. A product as described in claim 1 wherein the fiber comprises at least one of aramid fibers, carbon fibers, glass fibers, basalt fibers, polymer fibers, wood fibers, cellulose, fiber reinforced polymer, carbon-fiber-reinforced polymer, carbon-fiber-reinforced plastic, carbon-fiber reinforced thermoplastic, or carbon nanotube reinforced polymer.

6. A product as described in claim 1 wherein the bonding agent comprises a resin comprising at least one of vinylester resin, polyester resin, epoxy resin, phenolic resin, or modified phenolic resin.

7. A product as described in claim 1 wherein the bonding agent is pre-impregnated into at least one of the fiber or the weave.

8. A product comprising:
a composite material comprising a metal core, a fiber comprising carbon, a weave comprising glass, and a bonding agent, wherein the weave is positioned between the metal core and the fiber.

9. A product as described in claim 8 wherein the metal core comprises aluminum.

10. A product as described in claim 8 wherein the core comprises a honeycomb structure comprising a plurality of n-sided polygonal or circular holes.

11. A product as described in claim 8 wherein the bonding agent comprises a resin comprising at least one of vinylester resin, polyester resin, epoxy resin, phenolic resin, or modified phenolic resin.

12. A product as described in claim 8 wherein the bonding agent is pre-impregnated into at least one of the fiber or the weave.

13. A product as described in claim 8 wherein the bonding agent bonds the fiber to at least one of the metal core or the weave.

14. A method of manufacturing a composite material comprising:
providing a core, a fiber, a weave, and a bonding agent,
positioning the weave over the core,
positioning the fiber and bonding agent over the weave, and
curing to form the composite material.

15. A method as described in claim 14 wherein the bonding agent comprises at least one of vinylester resin, polyester resin, epoxy resin, phenolic resin, or modified phenolic resin.

16. A method as described in claim 14 wherein the core comprises aluminum.

17. A method as described in claim 14 wherein the core comprises a honeycomb structure comprising a plurality of n-sided polygonal or circular holes.

18. A method as described in claim 14 wherein the weave comprises at least one of aramid fibers, carbon fibers, glass fibers, basalt fibers, polymer fibers, wood fibers, cellulose or fiber reinforced polymer.

19. A method as described in claim 14 wherein the fiber comprises at least one of aramid fibers, carbon fibers, glass fibers, basalt fibers, polymer fibers, wood fibers, cellulose, fiber reinforced polymer, carbon-fiber-reinforced polymer, carbon-fiber-reinforced plastic, carbon-fiber reinforced thermoplastic, or carbon nanotube reinforced polymer.

20. A method of manufacturing a composite material comprising:
providing a mold cavity, a core, a first fiber, a second fiber, a first weave, a second weave, a first bonding agent, and a second bonding agent,
positioning the first fiber and the first bonding agent into the mold cavity,
positioning the first weave over the first fiber,
positioning the core over the first weave,
positioning the second weave over the core,
positioning the second fiber and the second bonding agent over the second weave,
closing the mold cavity,
and curing to form the composite material.
